(19) United States
(12) Patent Application Publication
(10) Pub. No.: US 2014/0032001 A1
(43) Pub. Date: Jan. 30, 2014

(54) DEMAND SIDE MANAGEMENT CONTROL SYSTEM AND METHODS

(71) Applicants: Eunhee Kim, Louisville, KY (US); Daryl Williams, Louisville, KY (US); Seog Tae Kim, Louisville, KY (US)

(72) Inventors: Eunhee Kim, Louisville, KY (US); Daryl Williams, Louisville, KY (US); Seog Tae Kim, Louisville, KY (US)

(21) Appl. No.: 13/558,448

(22) Filed: Jul. 26, 2012

(51) Int. Cl. G06F 1/26

(52) U.S. Cl. 700/295

(57) ABSTRACT

A demand side management control system and method for altering power consumption on an electrical device during specified periods of time (e.g., peak energy demand periods). The system includes a memory to store two or more power consuming function profiles corresponding to the one or more power consuming functions associated with the electrical device. The system also includes at least one processor coupled with the memory. The processor is programmed to receive a peak energy demand signal and access the power consuming function profiles associated with the electrical device. The processor identifies, based on the received peak energy demand signal, the one of two or more power consuming function profiles to be implemented in the electrical device. Finally, the processor periodically disables or operates at a reduced power level at least one power consuming function according to the identified power consuming function profile.

### BACKGROUND OF THE INVENTION

The field of the disclosure relates generally to altering power consuming functions on an electrical device, and more specifically to a system and method for altering power consuming functions on an electrical device during periods of peak energy demand.

In consideration of increasing fuel prices and high rates of energy usage at certain parts of the day (e.g., peak demand periods), electric utilities may be required to buy high cost energy (e.g., peaking energy) in order to supply their customers during these periods. Accordingly, electric utilities charge their customers higher rates during peak demand periods. By reducing energy usage during peak demand periods, utilities can achieve commercially significant cost savings by reducing their investment in peaking energy and overall generation.

More recently, various types of dynamic pricing, such as real-time energy pricing, have been introduced to the energy consumer. Dynamic pricing provides some market transparency that exposes consumers to demand-based variations in energy costs. Accordingly, consumers are encouraged to reduce their use of energy during periods of high demand, lowering their electric utility bill. The prevalence of dynamic pricing is growing as a means to mitigate power shortages. In this context, dynamic pricing is referred to as a “demand response”. Utilities and their regulators have implemented demand response as programs, which provide incentives to reduce electrical demand during peak energy usage, when brownouts and power shortages are most likely. In some cases, these incentives are contingent upon a consumer maintaining energy usage below a threshold during certain hours or metering intervals. If the consumer fails to operate under this threshold, the incentives may be lost, penalties may be imposed, or both.

### BRIEF DESCRIPTION OF THE INVENTION

In one aspect, a system to alter power consumption of an electrical device is provided. The system includes a memory to store two or more power consuming function profiles corresponding to one or more power consuming functions associated with the electrical device. The system also includes at least one processor coupled with the memory and programmed to receive a peak energy demand signal. The processor is further programmed to access the power consuming function profiles associated with the electrical device and identify, based on the received peak energy demand signal, one power consuming function profile to be implemented in the electrical device to reduce energy consumption of the device. The processor is operative to periodically disable or operate at a reduced power level at least one power consuming function according to the identified power consuming function profile.

In another aspect, a method is provided. The method includes receiving a peak energy demand signal and accessing power consuming function profiles associated with an electrical device. The method also includes identifying, based on the received peak energy demand signal, one of the two or more power consuming function profiles to be implemented in the electrical device to reduce energy usage of the device. Finally, the method includes disabling or operating at a reduced power level, in the electrical device, at least one power consuming function according to the identified power consuming function profile.

In yet another aspect, an electrical appliance is provided. The electrical appliance includes a memory to store power consuming function profiles corresponding to one or more power consuming functions associated with the electrical appliance. The appliance also includes at least one processor programmed to receive a peak energy demand signal, access the power consuming function profiles associated with the electrical device, and identify, based on the received peak energy demand signal, the power consuming function profile to be implemented in the electrical device in order to reduce energy usage of the device. The processor is operative to periodically disable or operate at a reduced power level, in the electrical device, at least one power consuming function according to the identified power consuming function profile.

### BRIEF DESCRIPTION OF THE DRAWINGS

The present disclosure is described in detail below with reference to the attached figures.

FIG. 1 is a perspective view of an exemplary speedcook oven.

FIG. 2 is a schematic view of the speedcook oven shown in FIG. 1.

FIG. 3 is a schematic diagram of heating sources in a speedcook oven.

FIG. 4 is a schematic system block diagram of an electrical energy measurement system.

FIG. 5 is a schematic illustration of a speedcook oven when it is operating in the normal cooking algorithm.

FIG. 6 is an illustration of periodic disabling of certain heating elements in the speedcook oven when it is operating in the reduced peak power cooking algorithm.

FIG. 7 is a process flow diagram of a method for modifying power consumption of an electric device.

### DETAILED DESCRIPTION OF THE INVENTION

While embodiments of the disclosure are illustrated and described herein with reference to altering power consuming functions on an electrical device, and more specifically to a system and method for altering power consuming functions on an electrical device during periods of peak energy demand, aspects of the disclosure are operable with any system that performs the functionality illustrated and described herein, or its equivalent.

Dynamic pricing provides market transparency that exposes customers to time variations in energy costs, encouraging customers to shift their electrical energy usage into periods of lower demand, and therefore, lower prices. In recent years, a companion system to the dynamic pricing model has been introduced which provides an automatic means for customers to take advantage of dynamic pricing and electric energy utilities to more precisely manage energy demand. Typically, the total energy demand of a home or facility fluctuates markedly, due to many individual electrical loads turning on and off at irregular intervals. Thus, a utility's ability to refine load control to a higher degree of precision, for example, at an individual electrical device level, can produce greater accuracies and better performance in load control strategies. Referred to as “demand side management,” (“DSM”) this system uses a communication link from the utility to the customer's home to deliver a signal (e.g., a peak energy demand signal) indicating a peak demand period. Controllers in the customer's homes and facilities receive this signal, and act to eliminate certain electric loads automatically until the signal is no longer being received.

For example, on hot days, the air conditioning unit of a home HVAC system typically makes up the greatest portion of a customer's energy demand. During mid-afternoon hours, when air conditioning units may be operating constantly, the utility may reduce its overall energy demand by periodically sending a peak energy demand signal to customer's homes, causing their air conditioning units to temporarily shut down. Customers who allow the utility to install DSM controllers in their home are charged lower prices.

Dynamic pricing and DSM are being increasingly used to mitigate power shortages and, in this context, it is referred to as a “demand response”. Utilities and their regulators have implemented demand response as programs, which provide energy consumers incentives to reduce electrical demand during power shortages. In some cases, these incentives are contingent upon a customer reducing their energy usage below a predetermined threshold during each hour or each metering interval. If the customer fails to observe these limits, the incentives may be lost, penalties may be imposed, or both. With DSM, customers are given incentives based not on adhering to an energy usage limit, but instead on allowing the electric utility to reduce energy loads as desired by the utility.

However, there may be times where a customer would like to use a high power (e.g., high wattage) DSM-controlled appliance (e.g., a speedcook oven) without a significant reduction in its performance due to the DSM control. Aspects of the present disclosure provide an electrical device which utilizes multiple power consuming function profiles to operate individual components for a normal cooking algorithm and a reduced power cooking algorithm (e.g., when the device is receiving a peak energy demand signal).

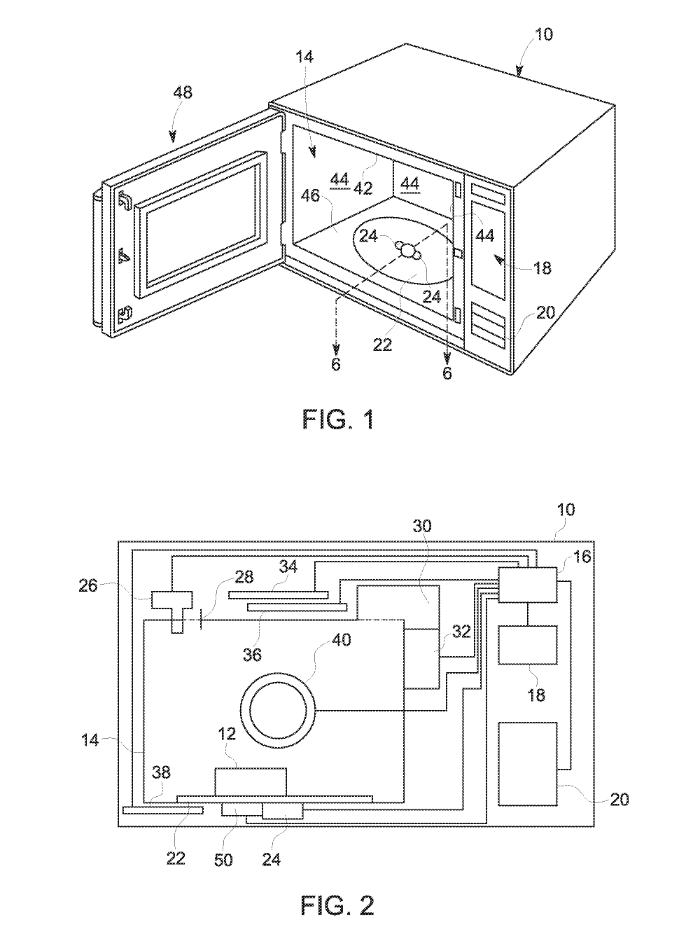

Referring now to the figures, FIG. 1 shows a speedcook oven 10, according to an exemplary embodiment. As shown in FIGS. 1 through 3, speedcook oven 10 includes a cavity 14, controller 16, a display 18, a control panel 20, a table 22, a table motor 24, a sensor 26, a vent 28, and a guide 30. The speedcook oven 10 further includes a generator 32 that generates microwaves (e.g., a magnetron), a front upper heating element 34, a rear upper heating element 36, a lower heating element 38, and a convection heating assembly (not shown). According to an exemplary embodiment, the convection heating assembly includes a convection heating element 40 and a heat distributing fan (not shown). In an alternative embodiment, any oven having at least one heating source can be employed in place of a speedcook oven 10.

The term “controller” as used herein is not limited to just those integrated circuits referred to in the art as controllers, but broadly refers to controllers, processors, microcontrollers, microcomputers, programmable logic controllers, application specific integrated circuits, and other programmable circuits, and these terms are used interchangeably herein. Examples of display 18 include a light emitting diode (LED) display and a vacuum fluorescent display (VFD). An example of generator 32 includes a magnetron that generates microwaves, as well as other dielectric heating elements. Examples of front upper heating element 34, rear upper heating element 36, lower heating element 38, and convection heating element 40 include conduction heating elements, radiant heating elements or convection heating elements. Controller 16 is communicatively coupled to display 18, control panel 20, table motor 24, sensor 26, generator 32, front upper heating element 34, rear upper heating element 36, lower heating element 38, and convection heating element 40. As used herein, the term “communicatively coupled,” or variations thereof, refers to a link, such as a conductor, a wire, and/or a data link, between two or more components of speedcook oven 10 that enables signals, electric currents, and/or commands to be communicated between the two or more components. The link is configured to enable one component to control an operation of another component of speedcook oven 10 using the communicated signals, electric currents, and/or commands.

Speedcook oven 10 includes cavity 14 defined by a top wall 42, side walls 44, a bottom wall 46, and a door 48. A user places item 12 inside cavity 14 on table 22 for heating item 12. In the exemplary embodiment, table 22 is transparent or substantially transparent, as described in more detail below. The user uses control panel 20 to operate speedcook oven 10. Control panel 20 provides various options to the user to heat item 12. As one example, the user uses control panel 20 to enter an amount of time for which the user desires to heat item 12. As another example, the user uses control panel 20 to enter the type of item 12 that the user desires to heat. Display 18 shows the user one or all of the various options that the user selects using control panel 20. As an example, display 18 shows the time for which the user desires to heat item 12 and a countdown of the time as item 12 is being heated. As another example, display 18 shows the status of the heating elements of the speedcook oven 10.

During operation of speedcook oven 10, generator 32 may generates microwaves which are delivered to cavity 14 via guide 30. Also during operation, one or more of front upper heating element 34, rear upper heating element 36, lower heating element 38, and convection heating element 40 are activated, generating heat that is substantially maintained inside the cavity 14. A cooling fan (not shown) cools generator 32. According to an embodiment, item 12 is heated by energy of the microwaves and other heat sources. Microwaves specifically can cause moisture to leave item 12 into the air within cavity 14. Sensor 26 provides a signal, such as a voltage signal or a current signal, to controller 16. The signal corresponds to a level of humidity inside cavity 14, which is measured when moisture content of air inside cavity 14 is being exhausted via vent 28. Controller 16 receives the signal from sensor 26 and controls power level of generator 32 during operation of speedcook oven 10. Controller 16 can further control a rotation of table 22 via table motor 24. In the exemplary embodiment, table 22 rotates while item 12 is being heated. Further, controller 16 controls a lighting system 50 to illuminate cavity 14 when door 48 is open and/or when item 12 is being heated and/or in response to actuation by the user of a manually actuable light switch disposed on control panel 20.

With reference to FIG. 4, a schematic block diagram of an electric energy management system 100 is provided. System 100 includes a controller 102 communicatively coupled to a meter 104, which is configured to measure electric energy usage, and a home area network (HAN) user interface 106. Controller 102 is also communicatively coupled with one or more electrical devices 108 so that devices 108 can receive one or more signals outputted from controller 102 that adjust and/or enable or disable one or more power consumption modes or settings of devices 108. The signals outputted from controller 102 allocate energy to electrical devices 108, and may be based on one or more of: data outputted from meter 104 which is indicative of energy usage by electrical devices 108, a demand limit (e.g., an amount of energy available during a peak demand period, an off-peak demand period, a high demand period, a low demand period, and/or one or more intermediate demand); a prioritization of electrical devices 108 (e.g., certain electrical devices are allocated energy before other electrical devices and/or are allocated more energy than other electrical devices); and an energy need level of electrical devices 108 (e.g., a level each electrical device 108 requires to function at a desired state).

Controller 102 may be a portable computing device such as, but not limited to: a smartphone, a laptop, a computer tablet, a netbook, and/or a portable media player. Further, controller 102 may include any device executing instructions (e.g., application programs), or any group of processing units or other controllers. In addition, although controller 102, meter 104, and HAN user interface 106 are shown as being separate devices in FIG. 4, features of device 102, meter 104, and HAN user interface 106 may be combined into, for example, one or more devices. For example, electrical device(s) 108 may include HAN user interface 106 and/or controller 102. Further, controller 102 may include a user interface (e.g., HAN user interface 106).

Controller 102 may communicate with meter 104, HAN user interface 106, and electrical devices 108 via wired and/or wireless networks, for example, local area networks or global networks such as the Internet. In one embodiment in which controller 102 communicates using wireless networks, controller 102 is enabled with technology such as BLUETOOTH brand wireless communication services (secured or unsecured), radio frequency identification (RFID), Wi-Fi such as peer-to-peer Wi-Fi, ZIGBEE brand wireless communication services, near field communication (NFC), and other technologies that enable short-range or long-range wireless communication. In some embodiments, controller 102 communicates via a wireless cellular network providing Internet access.

Controller 102 includes a memory 110, a display 114 and at least one processor 112. Display 114 may be, for example, an LED or LCD that displays energy used. In one embodiment, display 114 performs the functionalities of HAN user interface 106. As discussed above, HAN user interface 106 may be separate from (as shown in FIG. 4) or integrated within controller 102 as display 114. HAN user interface 106 and/or display 114 act as a user input selection device providing user input functionality. In one embodiment, HAN user interface 106 and/or display 114 may be a capacitive touch screen display configured to be responsive to a user contacting a screen to selectively perform functionality. Thus, a user can operate the desired functions by contacting a surface of HAN user interface 106 and/or display 114 as well as other functions provided herein.

Memory 110 or other computer-readable medium or media, stores power consuming function profiles 116 (e.g., an overview of how much power each function of the electrical device uses over a period of time) corresponding to one or more power consuming functions associated with one or more electrical devices 108. According to an illustrative embodiment, a power consuming function profile of a speedcook oven includes the amount of power used by each heating element in the oven, including conductive, convection, and microwave elements. Using this information, the various elements can be selectively enabled so that the overall power usage of the speedcook oven doesn't exceed a desired threshold. While memory 110 is shown to be stored in controller 102, in some embodiments memory 110 is remote from controller 102 and is coupled with controller 102 and/or processor 112, for example, via a cloud service or other remote network. Such configurations can reduce the computational and storage burden on controller 102.

Processor 112 accesses and executes computer-executable instructions. In some embodiments, processor 112 is transformed into a special purpose microprocessor by executing computer-executable instructions or by otherwise being programmed. For example, processor 112 is programmed with instructions such as illustrated below with respect to FIG. 4.

Controller 102 is configured to selectively adjust and/or disable at least one of the one or more power consuming features/functions (e.g., disable a heating element in an oven or limit the amount of power a heating element can draw) of electrical device(s) 108 to reduce power consumption of electrical device(s) 108. With this arrangement electrical device(s) 108, and in particular speedcook oven 10, can be operated in an energy savings mode during peak demand.

It should be appreciated that controller 102 can be configured with default settings which govern a normal cooking algorithm (e.g., during non-peak demand periods) and a reduced power cooking algorithm (e.g., during peak demand periods). Such settings in each mode can be fixed while others are adjustable to user preference and to provide response to load shedding signals from meter 104.

If controller 102 receives and processes an energy signal (or data) indicative of a peak demand period (e.g., a peak energy demand signal) from, for example, meter 104 at any time during operation of electrical device(s) 108, controller 102 processes this signal (or data) to determine and identify which if any of the power consuming features/functions may be operated in an energy savings mode. Controller 102 outputs one or more signals to electrical devices 108. The signal(s) outputted from controller 102 cause the identified features/functions of electrical device(s) 108 to begin operating in the energy savings mode in order to reduce the instantaneous amount of energy being consumed.

In one embodiment, prior to entering an energy savings mode, controller 102 provides a user with a warning via, for example, display 114 indicating a start of an energy savings mode. At this time, or anytime thereafter, the user may override the energy savings mode of one or more of the power consuming features/functions of electrical device(s) 108 via user interface 106. In one embodiment, a manual or selectable override is provided on user interface 106 to enable a user the ability to select which of the power consuming features/functions are delayed, adjusted and/or disabled by controller 102 in the energy savings mode prior to or after controller 102 provides user with a warning. The user can override any adjustments, whether time related or function related, to any of the power consuming functions.

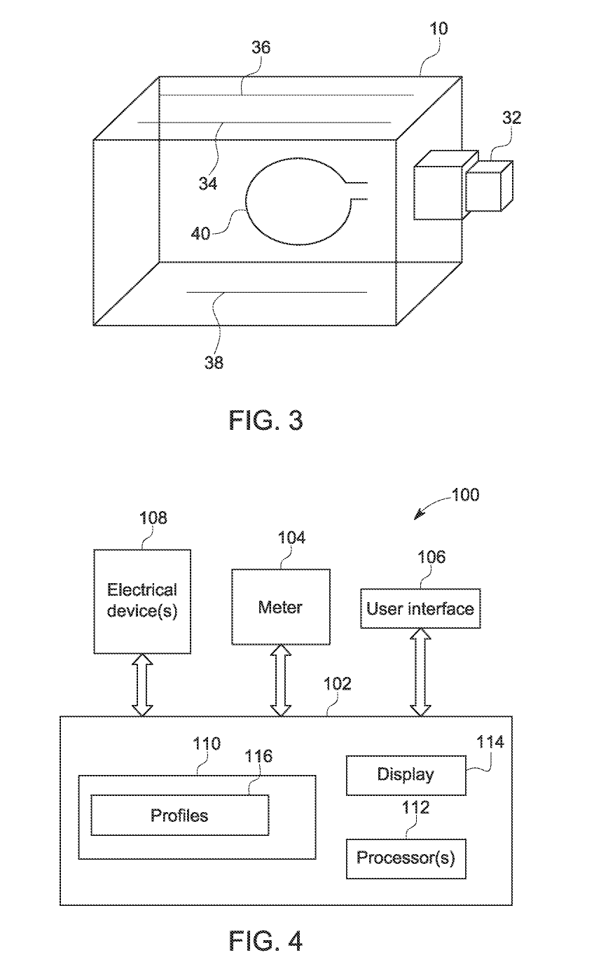

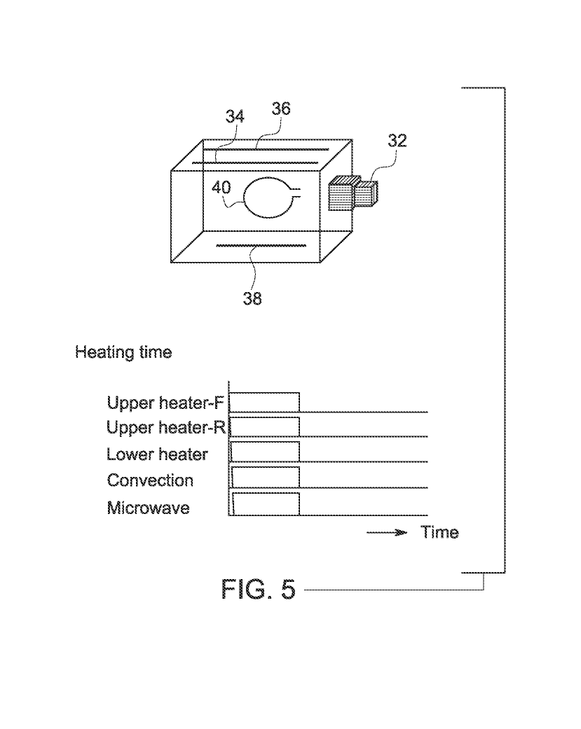

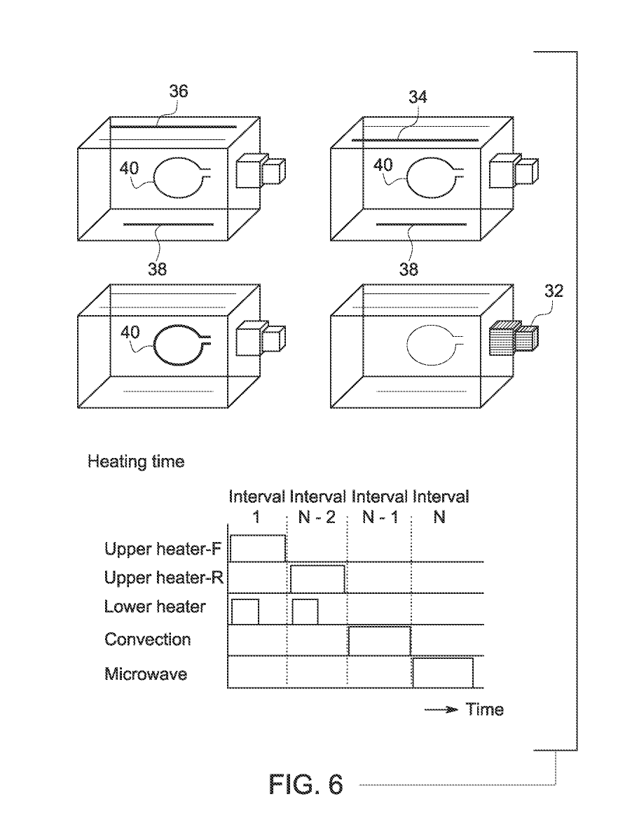

According to an exemplary embodiment, controller 102 in speedcook oven 10 (as shown in FIG. 3) can operate as few as one heating element at a time. Controller 102 is configured to energize at least one heating element to operate a cooking algorithm (e.g., power consuming function profile) selected by the user with control panel 20. Operation and modulation of the multiple heating elements of speedcook oven 10 is based on data entered by the user, food type, quantity to be cooked, and size or doneness desired. The memory 110 is configured to store at least two sets of cooking algorithms: a normal cooking algorithm to potentially utilize heating elements at their maximum designed load and a reduced power cooking algorithm to utilize a limited number of heating elements or reduced wattages to reduce total energy used for cooking. According to an embodiment, FIG. 5 is an illustration of speedcook oven 10 when it is operating according to the normal cooking algorithm, in which oven 10 is configured to operate at 240 Volts. According to FIG. 5, the normal cooking algorithm may use approximately 6,500 Watts of energy to perform a cooking task. FIG. 6 is an illustration of periodic disabling of certain heating elements in the speedcook oven when it is operating according to the reduced power cooking algorithm, in which oven 10 is configured to operate at 120 Volts. According to FIG. 6, the reduced power cooking algorithm uses approximately 1,800 Watts of energy to perform the same cooking task.

In one embodiment, the identification of which power consuming features/functions are operated in an energy savings mode for an electrical device depends on what “stage” the electrical device is currently operating. For example, an identification of which power consuming features/functions are operated in an energy savings mode for speedcook oven 10 may depend on whether speedcook oven 10 is currently operating in a cooking algorithm. In one embodiment, controller 102 includes functionality to determine whether activation of the energy savings mode for any power consuming features/functions would potentially cause damage to any feature/function of speedcook oven 10 itself or would cause speedcook oven 10 to fail to perform its intended function of cooking food to a particular level of doneness. Details of this functionality are further described below. If controller 102 determines that an unacceptable consequence may occur by performing an energy saving action, such as deactivating or curtailing the operation of speedcook oven 10, controller 102 may opt-out of performing that specific energy saving action or may institute or extend other procedures.

The duration of time that electrical device(s) 108 operates in the energy savings mode may be determined by information in a peak energy demand signal received from a utility provider directly when immediate load reduction is necessary or otherwise through meter 104. The energy signal may be indicative of a utility state (defined above), and may contain data that causes controller 102 to operate electrical devices 108 in an energy savings mode for a predetermined time, after which electrical device(s) 108 return to normal operation. In one embodiment, once transmission of the energy signal has ceased, electrical device(s) 108 returns to normal operating mode. In yet another embodiment, an energy signal is transmitted to controller 102 to signal electrical device(s) 108 to operate in the energy savings mode and a normal operation signal is later transmitted to controller 102 to cause controller 102 to output a signal that causes electrical device(s) 108 to return to the normal operating mode.

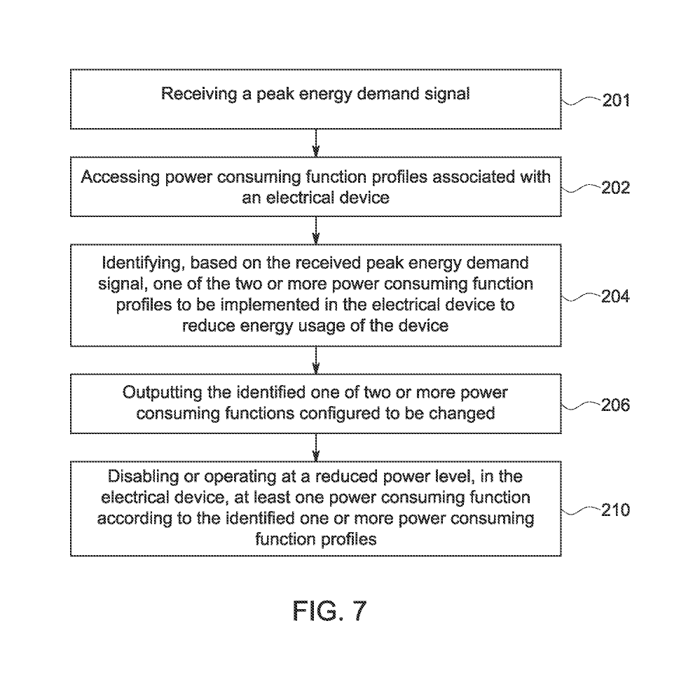

Referring now to FIG. 7, an exemplary flow chart illustrates the controller 102 and/or the processor 112 altering the operation of power consuming functions on an electrical device (e.g., electrical device(s) 108 in FIG. 1) during a specified period of time (e.g., a period of peak energy demand). The power consuming function profiles include parameters for each power consuming function of each electrical device(s) 108. For example, a power consuming function profile may indicate when a particular power consuming function is or is not to be disabled or operated at reduced power during a peak demand. At 201, a peak energy demand signal is received by processor 112, indicating a peak demand period. At 202, power consuming function profiles associated with electrical device(s) 108 are accessed by, for example, controller 102 (shown in FIG. 1), and more specifically, processor 112 (shown in FIG. 1). In one embodiment, power consuming function profiles are accessed when it is determined to place electrical device(s) 108 in an energy savings mode, for example, when a peak energy demand signal is received. At 204, processor 112 uses the accessed power consuming function profiles to identify, based on a received peak energy demand signal, one or more power consuming functions (e.g., collectively a power consuming function profile) that can be changed during the specified period of time, to reduce energy consumption by electrical device(s) 108.

At 206, processor 112 outputs the identified power consuming functions that can be changed during a specified period of time (e.g., a time of peak energy demand). During times of peak demand, processor 112 may automatically output one or more signals to electrical device(s) 108 that disable or operate at a reduced power level one or more power consuming functions of electrical device(s) 108. Processor 112 identifies the power consuming functions at the beginning of or during a specified period of time (e.g., during a period of a peak energy demand). Alternatively or additionally, processor 112 could be configured to identify the power consuming functions upon receiving a request from the user interface. For example, a user may request to see which power consuming functions of electrical device(s) 108 will be altered during a peak energy demand for the current system configuration.

According to an embodiment, processor 112 determines if a request to not change at least one of the identified one or more power consuming functions during a peak energy demand is received from the user interface. In one embodiment, a user may be informed via, for example, a message on display 114 that a particular power consuming function is either disabled or operating in a reduced power mode or is about to be disabled or operated in a reduced power mode due to a peak energy demand. In response to this message, the user may override the current settings that will otherwise disable or operate at reduced power the one or more power consuming functions by requesting that the identified power consuming functions be prevented from being modified during the specified time period (e.g., the peak energy demand period). In addition, the user may choose to delay the disabling or operating at reduced power of the one or more power consuming functions for a specified period of time.

At 210, processor 112 periodically disables or operates at a reduced power level, in the electrical device, at least one power consuming function according to the identified power consuming function profiles.

### Exemplary Operating Environment

A controller or computing device such as described herein has one or more processors or processing units, system memory, and some form of computer readable media. By way of example and not limitation, computer readable media include computer storage media and communication media. Computer storage media include volatile and nonvolatile, removable and non-removable media implemented in any method or technology for storage of information such as computer readable instructions, data structures, program modules or other data. Communication media typically embody computer readable instructions, data structures, program modules, or other data in a modulated data signal, such as a carrier wave or other transport mechanism, and include any information delivery media. Combinations of any of the above are also included within the scope of computer readable media.

The controller/computer may operate in a networked environment using logical connections to one or more remote computers, such as a remote computer. Although described in connection with an exemplary computing system environment, embodiments of the present disclosure are operational with numerous other general purpose or special purpose computing system environments or configurations. The computing system environment is not intended to suggest any limitation as to the scope of use or functionality of any aspect of the present disclosure. Moreover, the computing system environment should not be interpreted as having any dependency or requirement relating to any one or combination of components illustrated in the exemplary operating environment. Examples of well known computing systems, environments, and/or configurations that may be suitable for use with aspects of the present disclosure include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the present disclosure may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the present disclosure may be implemented with any number and organization of such components or modules. For example, aspects of the present disclosure are not limited to the specific computer-executable instructions or the specific components or modules illustrated in the figures and described herein. Other embodiments of the present disclosure may include different computer-executable instructions or components having more or less functionality than illustrated and described herein. Aspects of the present disclosure may also be practiced in distributed computing environments where tasks are performed by remote processing devices that are linked through a communications network. In a distributed computing environment, program modules may be located in both local and remote computer storage media including memory storage devices.

Aspects of the present disclosure transform a general-purpose computer into a special-purpose computing device when configured to execute the instructions described herein.

The order of execution or performance of the operations in embodiments of the present disclosure illustrated and described herein is not essential, unless otherwise specified. That is, the operations may be performed in any order, unless otherwise specified, and embodiments of the present disclosure may include additional or fewer operations than those disclosed herein. For example, it is contemplated that executing or performing a particular operation before, contemporaneously with, or after another operation is within the scope of aspects of the present disclosure.

When introducing elements of aspects of the present disclosure or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the present disclosure in detail, it will be apparent that modifications and variations are possible without departing from the scope of aspects of the present disclosure as defined in the appended claims. As various changes could be made in the above constructions, products, and methods without departing from the scope of aspects of the present disclosure, it is intended that all matter contained in the above description and shown in the accompanying drawings shall be interpreted as illustrative and not in a limiting sense.

This written description uses examples to disclose the claimed subject matter, including the best mode, and also to enable any person skilled in the art to practice the claimed subject matter, including making and using any devices or systems and performing any incorporated methods. The patentable scope of the present disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A control system for an electrical device, said system comprising:
a memory configured to store two or more power consuming function profiles corresponding to one or more power consuming functions associated with the electrical device; and
at least one processor coupled with said memory and programmed to:
receive a peak energy demand signal;
access the power consuming function profiles associated with the electrical device;
identify, based on the received peak energy demand signal, one power consuming function profile to be implemented in the electrical device to reduce energy consumption of the device; and
periodically disable or operate at a reduced power level at least one power consuming function according to the identified one or more power consuming function profiles.

2. The system of claim 1, wherein the electrical device is one of an oven, a microwave oven and a speedcook oven.

3. The system of claim 1, wherein the at least one processor is further programmed to:
receive a normal operation signal;
access the power consuming function profiles associated with the electrical device;
identify, based on the presence of the normal operation signal, one power consuming function profile to be implemented in the electrical device to operate the device without otherwise reducing its energy consumption; and
enable power consuming functions according to the identified power consuming function profiles.

4. The system of claim 1, wherein the at least one processor is further programmed to:
receive no peak energy demand signal;
access the power consuming function profiles associated with the electrical device;
identify, based on the absence of the peak energy demand signal, one of power consuming function profiles to be implemented in the electrical device to operate the device without otherwise reducing its energy consumption; and
enable power consuming functions according to the identified power consuming function profile.

5. The system of claim 1, wherein when the presence of a peak energy demand signal is detected, the processor disables or operates at reduced power one of the power consuming functions.

6. The system of claim 1, wherein the two or more power consuming functions comprise at least one of conduction heating, convection heating, radiant heating, dielectric heating, heating with a halogen lamp, heating with a ceramic lamp, heating with a sheath heater and heating with a magnetron.

7. The system of claim 1, wherein the two or more power consuming function profiles includes a normal cooking algorithm and a reduced power cooking algorithm.

8. The system of claim 7, wherein the reduced power cooking algorithm is configured to utilize less energy than the normal cooking algorithm.

9. The system of claim 1, wherein the peak energy demand signal is received from one of a meter, a power line and a utility provider.

10. The system of claim 1, further comprising a user interface coupled with said processor, said processor further programmed to receive a request from said user interface to enable or disable the peak energy demand signal.

11. A method of modifying power consumption of an electrical device comprising:
receiving a peak energy demand signal;
accessing power consuming function profiles;
identifying, based on the received peak energy demand signal, one of the two or more power consuming function profiles to be implemented to reduce energy usage; and
disabling or operating at a reduced power level at least one power consuming function according to the identified one or more power consuming function profiles.

12. The method of claim 11, wherein the at least one power consuming function comprises at least one of conduction heating, convection heating, radiant heating, dielectric heating, heating with a halogen lamp, heating with a ceramic lamp, heating with a sheath heater and heating with a magnetron.

13. The method of claim 11, further comprising:
presenting, via a user interface, the identified power consuming functions configured to be implemented in the electrical device; and
receiving, via the user interface, a request to not change the identified power consuming functions.

14. The method of claim 11, wherein the electrical device is one of an oven, a microwave oven and a speedcook oven.

15. An electrical appliance, comprising:
a memory to store power consuming function profiles corresponding to one or more power consuming functions associated with the electrical appliance; and
at least one processor programmed to:
receive a peak energy demand signal;
access the power consuming function profiles associated with the electrical appliance;
identify, based on the received peak energy demand signal, the power consuming function profile to be implemented in the electrical appliance in order to reduce energy usage of the appliance; and
periodically disable or operate at a reduced power level at least one power consuming function according to the identified power consuming function profiles.

16. The appliance of claim 15, wherein the electrical appliance is one of an oven, a microwave oven and a speedcook oven.

17. The appliance of claim 15, wherein, when the presence of a peak energy demand signal is detected, the processor cycles between at least two of the power consuming functions.

18. The appliance of claim 15, wherein, when the presence of a peak energy demand signal is detected, the processor disables or operates at reduced power one of the power consuming functions.

19. The appliance of claim 15, wherein the power consuming functions comprise at least one of conduction heating, convection heating, radiant heating, dielectric heating, heating with a halogen lamp, heating with a ceramic lamp, heating with a sheath heater and heating with a magnetron.

20. The appliance of claim 15, wherein the peak energy demand signal is received from one of a meter, a power line and a utility provider.
